(19) United States
(12) Patent Application Publication
(10) Pub. No.: US 2026/0278366 A1
(43) Pub. Date: Sep. 17, 2026

(54) METHODS AND APPARATUSES FOR TRAINING A GRAPH NEURAL NETWORK

(71) Applicant: Telefonaktiebolaget LM Ericsson (publ), Stockholm (SE)

(72) Inventors: Yifei JIN, Solna (SE); Marios DAOUTIS, Bromma (SE)

(21) Appl. No.: 19/167,200

(22) PCT Filed: Sep. 28, 2023
(86) PCT No.: PCT/SE2023/050957

§ 371 Date: Sep. 19, 2025

(30) Foreign Application Priority Data
Mar. 24, 2023 (GR) 20230100251

(51) Int. Cl. G06N 3/08; G06N 3/042

(52) U.S. Cl. CPC G06N 3/08; G06N 3/042

(57) ABSTRACT

Embodiments described herein relate to training a graph neural network, GNN, model. In particular the GNN model is trained to predict performance metrics for a network. A method for training the GNN model comprises: obtaining a graph representation of a network, wherein the graph representation comprises: a set of nodes, V, wherein each node represents a radio coverage area; and a set of edges, E, wherein each edge connects two nodes in the set of nodes and represents a relationship between the two nodes; obtaining sets of geometric features, G, associated with overlaps between respective radio coverage areas associated with at least some edges in the set of edges; conducting a first phase of training using one or more first output layers for the GNN model, wherein the first phase of training comprises training the GNN model to predict the sets of geometric features; after the first phase of training, selecting at least one first parameter of the GNN model to fix; and conducting a second phase of training using one or more second output layers in the GNN model to predict performance metrics associated with the set of nodes, wherein the second phase of training comprises training the GNN model with the at least one first parameter fixed.

### TECHNICAL FIELD

Embodiments described herein relate to methods and apparatuses for training a Graph Neural Network (GNN) model to predict performance metrics associated with radio coverage areas in a network. Further disclosed are computer program and computer program product for the same.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Estimating the performance metrics of wireless devices, i.e., user equipment (UE), in cellular networks has been a well-known and long-studied problem, in the context of network design and optimization (NDO) and network deployment. As the introduction of 6G telecommunication networks approaches, the future goal is to achieve a Self-Organized Network (SON), where performance metrics such as Quality of Service Key Performance Indicators (QoS KPIs) can be estimated, if possible, based on cell configurations.

Cell configuration parameters are usually devised and fine-tuned by Field Service Engineers in real world radio network deployments. Besides the domain knowledge involved in the configuration process, it is considered a laborious task which cannot be easily automated due to the complex relations and interactions between the network nodes. Furthermore, subtle configuration changes may considerably affect the network performance through characteristics such as coverage and interference.

Estimating radio-coverage-related QoS still remains a challenge, even for cell-level, mainly due to the complexities that emerge during Electric Magnetic Wave (EMW) propagation. To estimate a site with multiple cells' QoS KPI is NP-hard, whereas it is NP-complete if there exist many sites with heterogeneous inter-cell relations.

Conventional methods for such problems often rely on logic-based simulations, where the simulator integrates complex radio propagation models and computes the coverage quality on a per-cell basis. The simulator then integrates the results of each cell to produce the area's estimation. Despite the high accuracy of such approaches, these are usually computationally very expensive and, in some cases, infeasible for cellular coverage computations at scale.

Due to recent advances in deep learning (DL), graph neural networks (GNN) have been proposed as an alternative solution to solve computationally difficult sub-problems in a way that is time and computationally efficient. These sub-problems include estimating a coverage KPI of a single cell, estimating scenarios where a cell holds multiple users, and estimating multiple cell-user pairs which co-exist in the same scenario. For such prediction tasks, commonly used datasets include simulation data, crowd-sourcing data, road test measurement at a small scale, or a combination of the previous. For QoS KPI prediction tasks, network measurements are required in both quality and quantity, to act as ground truth.

The challenge of how to properly formulate the performance metric estimation task remains an open problem in the context of machine learning and representation learning. A successful formulation of representation would require:
1. Being expressive in terms of cell configuration parameters and inter-cell relations.
2. The ability to perform well with a limited amount of ground truth/measurements.
3. To learn from data available in a real network.

Graph representations have been adopted previously in the domain of radio networks, for example in the context of heterogeneous device configuration and network expansion. Some existing studies have used graph representations to address inter-cell relations but they do not consider important aspects such as the heterogeneity of the relations, relations beyond geographically adjacent cells, and spatial orientation of antenna, all of which impact the inter-cell relations. In other cases, hundreds of cell measurements are required which can be very resource-consuming.

Mobile service providers expect a model for estimating the performance metrics of cells in a network which can learn from network configurations and their respective measurements in real-world deployments, and scale-up from measurements of a few cells, instead of densely running road measurement tests or frequently triggering measurement reports for the serving users across many cells.

Thus, there is a need for a ML solution which solves the ground truth data constraints, especially when scaling up the estimation scenario to large geographical areas.

### SUMMARY

As described above, certain challenges currently exist regarding estimating the performance metrics of mobile users in cellular networks. One study (Z. Hu et al. “Gpt-gnn: Generative pre-training of graph neural networks”. In: SIGKDD. 2020, pp. 1857-1867) proposes a training framework which takes graph generation as pretext-tasks and produces pre-trained embeddings that can be generalized by finetuning some ground truth labels. However, this method is not suitable for a cellular network since one can easily determine the interfering or complementing relation by each cell's carrier so that little supervision can be expected. This method also requires more than 10% of the input data to be labelled for ground truth in the fine-tuning which then requires hundreds of cell measurements, exceeding the scale of the largest known road test dataset.

Another study (Y. Jin et al. “A Graph Attention Learning Approach to Antenna Tilt Optimization”. In: arXiv preprint arXiv:2112.14843 (2021)) addresses inter-cell relations through a graph representation for the problem of antenna tilt optimization, wherein cellular coverage embeddings have been used together with graph attention to capture the inter-cell relations. This is done in a multi-agent reinforcement learning framework, with identical action space for all antennas. However, the study has not considered few-shot-learning, while the reported results have not considered real-world scenarios and real networks. Only a few solutions (for example, E. Balevi et al. “Online Antenna Tuning in Heterogeneous Cellular Networks with Deep Reinforcement Learning”. In: arXiv preprint arXiv:1903.06787 (2019)) have been disclosed in the literature which try to address representations that capture inter-cell relations. Even fewer (for example, R. M. Dreifuerst et al. “Optimizing coverage and capacity in cellular networks using machine learning”. In: IEEE ICASSP. IEEE. 2021, pp. 8138-8142) have further considered heterogeneity (e.g., varying inter-site distance) in the cells' representation, which is common in real-world scenarios.

According to some embodiments there is provided a method for training a graph neural network, GNN, model. The method comprises obtaining a graph representation of a network, wherein the graph representation comprises: a set of nodes, V, wherein each node represents a radio coverage area; and a set of edges, E, wherein each edge connects two nodes in the set of nodes and represents a relationship between the two nodes; obtaining sets of geometric features, G, associated with overlaps between respective radio coverage areas associated with at least some edges in the set of edges; conducting a first phase of training using one or more first output layers for the GNN model, wherein the first phase of training comprises training the GNN model to predict the sets of geometric features; after the first phase of training, selecting at least one first parameter of the GNN model to fix; and conducting a second phase of training using one or more second output layers in the GNN model to predict performance metrics associated with the set of nodes, wherein the second phase of training comprises training the GNN model with the at least one first parameter fixed.

In further embodiments there is provided a method according to embodiments herein, wherein the sets of geometric features each comprise spatial configurations of overlaps between respective radio coverage areas.

In further embodiments there is provided a method according to embodiments herein, wherein each of the spatial configurations comprise one or more of: an interference area of the respective radio coverage area that interferes with one or more other radio coverage areas; a distance from the node to a centre of the interference area; and a location of the centre of the interference area.

In further embodiments there is provided a method according to embodiments herein, wherein the first phase of training further comprises: adjusting one or more second parameters associated with one or more first input layers of the GNN model.

In further embodiments there is provided a method according to embodiments herein. The method further comprising adjusting the one or more second parameters to reduce a value of a first loss function, wherein the first loss function is determined from: a first output of the GNN model during the first phase of training, and the sets of geometric features.

In further embodiments there is provided a method according to embodiments herein, wherein the step of selecting the at least one first parameter of the GNN model to fix comprises selecting the one or more second parameters as the at least one first parameter.

In further embodiments there is provided a method according to embodiments herein, wherein the second phase of training further comprises: adjusting one or more third parameters of the GNN model comprising one or more of: a parameters associated with one or more second output layers; and a parameters associated with one or more second input layers.

In further embodiments there is provided a method according to embodiments herein, wherein the second phase of training comprises adjusting the one or more third parameters in the GNN model to reduce a value of a second loss function.

In further embodiments there is provided a method according to embodiments herein. The method further comprising: obtaining measurements of the performance metrics from at least one node in the set of nodes, wherein the second loss function is determined from: a second output of the GNN model during the second phase of training, and the measurements of the performance metrics.

In further embodiments there is provided a method according to embodiments herein. The method further comprising obtaining first training configuration management, CM, parameters from the set of nodes.

In further embodiments there is provided a method according to embodiments herein. The method further comprising: determining the one or more sets of geometric features from the first training CM parameters.

In further embodiments there is provided a method according to embodiments herein, wherein the CM parameters comprise one or more of: a beamwidth of a radio coverage area provided by a node; a maximum transmission Power, a multiple-input and multiple-output (MIMO) scheme, an antenna height, an antenna orientation, an antenna electrical tilt, an antenna mechanical tilt, a sector identification, a carrier frequency, Downlink/Uplink E-UTRA

### Absolute Radio Frequency Channel Number.

In further embodiments there is provided a method according to embodiments herein, wherein the step of conducting the first phase of training comprises inputting the first training configuration management parameters into the GNN model.

In further embodiments there is provided a method according to embodiments herein, wherein the step of conducting the second phase of training comprises: obtaining second training configuration management, CM, parameters from the set of nodes; and inputting the second training configuration management parameters into the GNN model.

In further embodiments there is provided a method according to embodiments herein, wherein each edge in E has a direction.

In further embodiments there is provided a method according to embodiments herein, wherein the graph representation further comprises a set of node attributes, X, wherein each node attribute represents configuration parameters of a radio coverage area.

In further embodiments there is provided a method according to embodiments herein, wherein the graph representation further comprises a set of edge attributes, Y, wherein each edge attribute represents an inter-radio coverage area property between a source node and a destination node.

In further embodiments there is provided a method according to embodiments herein, wherein each edge attribute comprises one of: a representation of a geographical distance between the source node and the destination node; an indication of an inter-radio coverage area relation type being one or more of: interfering and complementing; and a representation of a strength of the inter-radio coverage area relation.

In further embodiments there is provided a method according to embodiments herein, wherein the graph representation further comprises sets of measurement features, M.

In further embodiments there is provided a method according to embodiments herein, wherein the sets of measurement features comprise representations of measured Received Signal Strength Indicators, RSSI.

According to some embodiments there is provided a method of using a trained GNN model, wherein the trained GNN model is trained as described in any embodiment herein.

In further embodiments there is provided a method according to embodiments herein. The method further comprising: inputting configuration management parameters from the set of nodes into the trained GNN model; and outputting, from the trained GNN model, predicted performance metrics associated with the set of nodes.

In further embodiments there is provided a method according to embodiments herein. The method comprising deploying the trained GNN model as a Recommendation Engine, RE.

In further embodiments there is provided a method according to embodiments herein. The method comprising deploying the trained GNN model as a digital twin, DT.

According to some embodiments there is provided an apparatus for training a graph neural network, GNN, model. The apparatus comprises processing circuitry configured to cause the apparatus to: obtain a graph representation of a network, wherein the graph representation comprises: a set of nodes, V, wherein each node represents a radio coverage area; and a set of edges, E, wherein each edge connects two nodes in the set of nodes and represents a relationship between the two nodes; obtain sets of geometric features, G, associated with overlaps between respective radio coverage areas associated with at least some edges in the set of edges; conduct a first phase of training using one or more first output layers for the GNN model, wherein the first phase of training comprises training the GNN model to predict the sets of geometric features; after the first phase of training, select at least one first parameter of the GNN model to fix; and conduct a second phase of training using one or more second output layers in the GNN model to predict performance metrics associated with the set of nodes, wherein the second phase of training comprises training the GNN model with the at least one first parameter fixed. In a further embodiment there is provided an apparatus according to embodiments herein, wherein the processing circuitry is further configured to perform a method according to embodiments herein.

According to some embodiments there is provided an apparatus for using a graph neural network, GNN, model, the apparatus comprising processing circuitry configured to use the GNN model, wherein the GNN model is trained according to any of the embodiments described herein. In a further embodiment there is provided an apparatus according to embodiments herein, wherein the processing circuitry is further configured to perform a method according to embodiments herein.

According to some embodiments there is provided a computer program comprising instructions which, when executed on at least one processor, cause the at least one processor to carry out a method according to any of the embodiments described herein.

According to some embodiments there is provided a computer program product comprising non transitory computer readable media having stored thereon a computer program according to embodiments herein.

Aspects and examples of the present disclosure thus provide methods and apparatuses allow for the training of a GNN model that can predict performance metrics for nodes in a network without requiring a large amount of ground truth data in order to train the GNN model.

For the purposes of the present disclosure, the term “ML model” encompasses within its scope the following concepts:
Machine Learning algorithms, comprising processes or instructions through which data may be used in a training process to generate a model artefact for performing a given task, or for representing a real world process or system;
the model artefact that is created by such a training process, and which comprises the computational architecture that performs the task; and
the process performed by the model artefact in order to complete the task.

References to “ML model”, “model”, model parameters”, “model information”, etc., may thus be understood as relating to any one or more of the above concepts encompassed within the scope of “ML model”.

### BRIEF DESCRIPTION OF THE DRAWINGS

For a better understanding of the embodiments of the present disclosure, and to show how it may be put into effect, reference will now be made, by way of example only, to the accompanying drawings, in which:

FIG. 1 illustrates an example method for training a GNN model, according to certain embodiments;

FIG. 2a illustrates an example of a radio network;

FIG. 2b illustrates a graph representation of the four beams of FIG. 2a;

FIG. 3 illustrates an example of a representation of a set of geometric features;

FIG. 4a illustrates the structure of the GNN during the first phase of training of the GNN model;

FIG. 4b illustrates an example of the structure of the GNN during the second phase of training of the GNN model;

FIG. 4c is a diagram representing QoS KPI values associated with four radio coverage areas, wherein the QoS KPI values comprise a range from Bad to Perfect;

FIG. 5 depicts a method 500 for implementing an inference phase of the GNN model;

FIG. 6 is a signalling diagram illustrating an example implementation of the methods of FIGS. 1 and 5;

FIG. 7 illustrates an apparatus comprising processing circuitry (or logic);

FIG. 8 is a block diagram illustrating an apparatus according to some embodiments;

FIG. 9 illustrates an apparatus comprising processing circuitry (or logic);

FIG. 10 is a block diagram illustrating an apparatus according to some embodiments.

### DETAILED DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, application specific integrated circuit(s) (ASICs), programmable logic device(s) (PLA), etc.) and/or using software programs and data in conjunction with one or more digital microprocessors or general-purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analogue) circuitry including but not limited to ASIC and/or field programmable gate array(s) (FPGA(s)), and (where appropriate) state machines capable of performing such functions.

Certain aspects of the present disclosure and their embodiments may provide solutions to the challenges mentioned above or other challenges. The steps of any methods disclosed herein do not have to be performed in the exact order disclosed, unless a step is explicitly described as following or preceding another step and/or where it is implicit that a step must follow or precede another step.

Particular embodiments are described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

Some embodiments include methods and apparatuses for training a graph neural network, GNN, model.

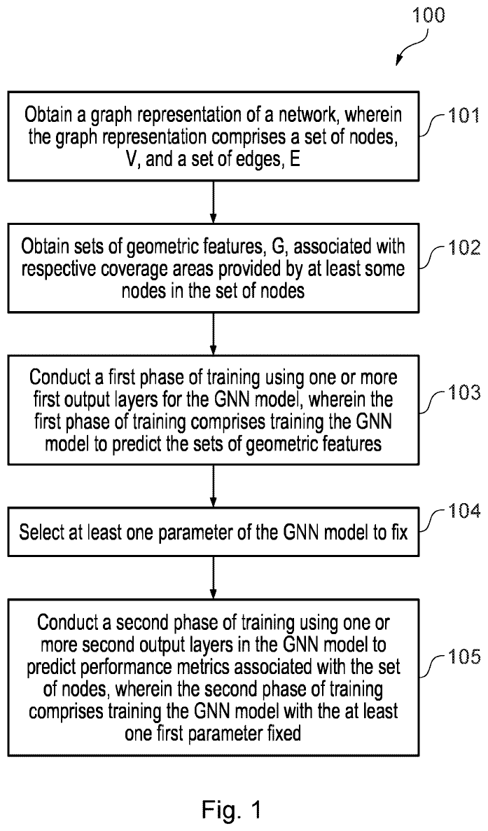

FIG. 1 illustrates an example method 100 for training a GNN model, according to certain embodiments.

The method 100 may be performed by a node, which may comprise a network node (such as a core network node), a physical or virtual node, and may be implemented in a computing device or server apparatus and/or in a virtualized environment, for example in a cloud, edge cloud or fog deployment. The node may be involved in network design and optimization (NDO). NDO denotes the design step in Network Deployment. NDO may be understood as designing how to deploy a network, for example, where to position the antenna/radios, how to best configure them, the process of figuring out the best choices for these parameters. In particular the method 100 may be implemented by the node in order to automate one or more steps of NDO.

In step 101 a graph representation of a network is obtained. For example, the graph representation may comprise a set of nodes, V, wherein each node represents a radio coverage area. It will be appreciated that a radio coverage area may comprise a cell or a beam provided by a network node (e.g. a base station in a radio access network). It may therefore also be appreciated that a single network node (e.g. a single base station) may provide more than one radio coverage area (e.g. more than one beam), and may therefore be represented by more than one node within the graph representation.

In addition, the graph representation may comprise a set of edges, E, wherein each edge connects two nodes in the set of nodes and represents a relationship between the two nodes.

In some embodiments, configuration management (CM) data of cells of interest in a requested area of interest is collected in a message queue (MQ) for NDO. The node performing the NDO may subscribe to the CM data by an identifier or a unique fingerprint that identifies the radio coverage areas in the network topology. In some embodiments, the fingerprint or identifier may comprise a Mobile Country Code (MCC), Mobile Network Code (MNC), Location Area Code (LAC) and Cell Identification (CI) coordinates. The node performing NDO may formulate a graph representation according to CM data from each radio coverage area.

A graph representation may be used to model inter-radio coverage area relations between, for example, cells or beams in a network.

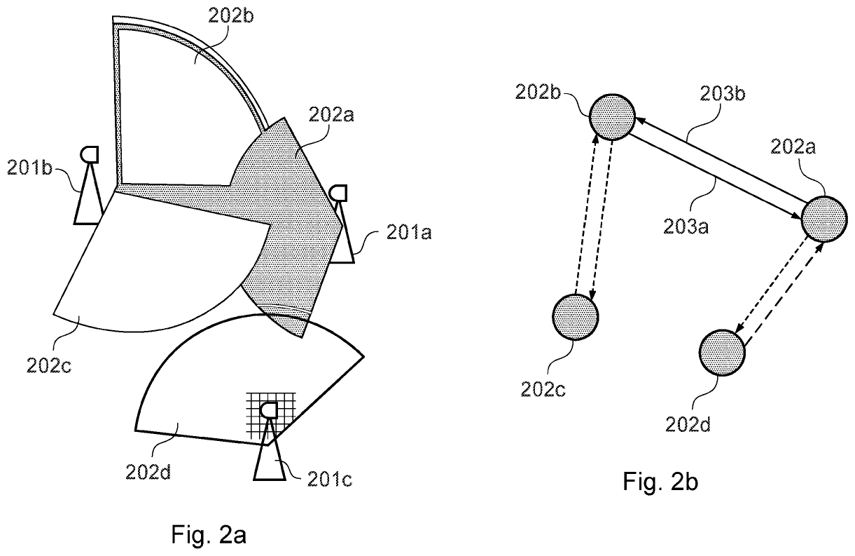

FIG. 2a illustrates an example of a radio network. This example network comprises three network nodes 201a to 201c collectively providing four beams, 202a to 202d. The coverage of each beam is depicted by a sector originating at a network node. In this example, the network node 201a provides the beam 202a, the network node 201b provides the beams 202b and 202c, and the network node 201c provides the beam 202d.

In this example, beams 202a and 202b both use at least a first carrier frequency. Beam 202c uses a third carrier frequency, and 202d uses a fourth carrier frequency.

FIG. 2b illustrates a graph representation of the four beams of FIG. 2a.

In the graph representation 200, the four beams are represented by nodes in the graph. As previously described, each node in the graph may represent a radio coverage area (in this example a beam). In addition, the graph representation 200 comprises edges between the nodes. Each edge may represent a relationship between two nodes. It will be appreciated that a relationship between nodes may exist when there are regions of overlap between the radio coverage areas represented by the nodes. Therefore, in this example network there are no edges between the nodes 202d and 202c as the corresponding beams do not overlap (as illustrated in FIG. 2a).

It will also be appreciated that the relationships between nodes may be either interfering or complementing. An interfering relationship is represented with a solid arrow, and a complementing relationship is represented with a dotted arrow.

As the nodes 202a and 202b represent coverage areas that utilise the same carrier frequency (e.g. the at least one first carrier frequency as described above), these coverage areas will be interfering. The edges between the nodes 202a and 202b are therefore represented with solid lines. Conversely the edges between 202a and 202d, and 202b and 202c, are dotted as the associated beams use different carrier frequencies and will therefore have complementing relationships.

The edges may be associated with a direction, wherein the direction of each edge is represented by an arrow directed away from a source node of the edge and towards a destination node of the edge. For example, each pair of nodes may be associated with two edges, one representing the interference from the first node to the second node, and one representing the interference from the second node to the first node.

For example, for the nodes 202a and 202b, a first edge 203a represents the interference caused by the node 202b at the node 202a. A second edge 203b represents the interference caused by the node 202a at the node 202b.

Additionally, each edge may comprise a weight representing the strength of the impact, wherein a larger weighting may represent a higher strength of impact. In FIG. 2b edges with higher weightings are represented with thicker lines. In the example of FIG. 2b therefore, the interference represented by the first edge 203a is greater than the interference represented by the second edge 203b.

In some embodiments, the graph representation may further comprise a set of node attributes, X, wherein each node attribute represents a set of configuration parameters for a radio coverage area associated with a node. A set of configuration parameters for a particular node, vᵢ, may be denoted as an array, xᵢ, which is an element of X.

It will be appreciated, as will be described later with reference to steps 103 and 104 that the configuration parameters of the nodes may be used as an input to the GNN model during training.

A configuration parameter for a node may comprise, for example, one of: a Beam Width, a Maximum Transmission Power, a multiple-input and multiple-output (MIMO) scheme, an Antenna Height, an Antenna Orientation, an Antenna Electrical tilt, an Antenna mechanical tilt, a Sector Id, a Carrier frequency, a Downlink/Uplink E-UTRA Absolute Radio Frequency Channel Number (earfcn) number. It will be appreciated that other types of configuration parameter may be used.

In some embodiments, the graph representation further comprises a set of edge attributes, Y, wherein each edge attribute represents an inter-radio coverage area property between the source node and the destination node of an associated edge. For example, for a particular edge between a source node, vᵢ, and a destination node, vⱼ, an edge attribute may be denoted as a, yᵢⱼ, which is an element of Y. It will be appreciated that yᵢⱼ may comprise any number of parameters, for example yᵢⱼ, may comprise a 3-dimensional array. For example, each edge attribute yᵢⱼ, may comprise one or more of: an indication of a geographical distance between the source node of an edge and the destination node of an edge, an indication of an inter-radio coverage area relation type (for example, one of: interfering and complementing), and a representation of a strength of the inter-radio coverage area relationship. As previously described, the edges yᵢⱼ and yⱼᵢ may be asymmetrical as vᵢ may interfere with the whole coverage of vⱼ while the interfering coverage of vⱼ may only take up a small portion of the coverage area of vᵢ.

In some embodiments, the graph representation further comprises a sets of measurement features, M. Each set of measurement features mᵢ∈M may be considered as an optional node attribute, xᵢ, of vᵢ∈V.

A set of measurement features may comprise representations of the measured Received Signal Strength Indicator (RSSI) associated with the radio coverage area of a node. It will be appreciated that at different points within a radio coverage are, the values of the measured RSSI will vary. A set of measurement features may therefore in some examples comprise a four-dimensional array indicating percentages of the radio coverage area which are associated with one of Perfect, Good, Fair or Bad values of measured RSSI. It will be appreciated that other types of measurement features may be used.

For example, mᵢ for a particular node vᵢ may equal=[Perfect=2%, Good=58%, Fair=15%, Bad=15%].

At step 102, sets of geometric features, G, associated with overlaps between respective radio coverage areas associated with at least some edges in the set of edges are obtained. It will be appreciated that the sets of geometric features, G, may be considered as part of the graph representation of the network. For example, a set of geometric features may be considered as additional edge attributes for an edge in the trained GNN. Alternatively, the obtaining of the sets of sets of geometric features may be considered as a pretext-task to the training of the GNN. In some embodiments, the sets of geometric features are added to the graph representation by augmenting the node and edge data for the graph representation. In another embodiment, the set of geometric features may be added to the graph representation by crowdsourcing data on User Equipment mobility traces that describe the geometric shape of the coverage area.

For example, the edge attributes across the graph may be augmented globally with G, regardless of whether or not vᵢ and vⱼ are using the same carrier frequencies or different carrier frequencies. It will however be appreciated that if different carrier frequencies are applied by two nodes of the graph representation, then the radio coverage areas will not interfere.

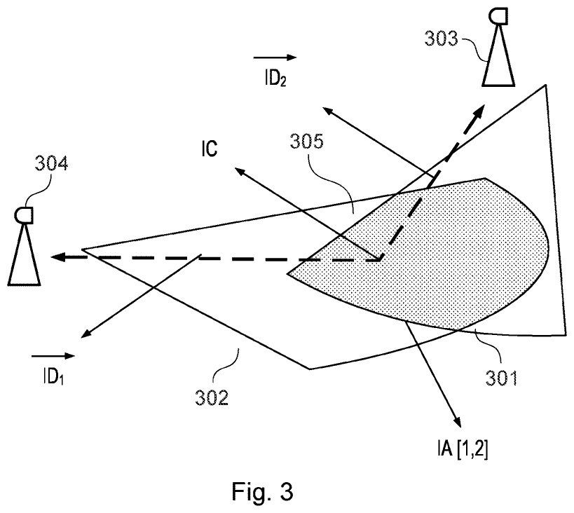

FIG. 3 illustrates an example of a representation of a set of geometric features, gᵢⱼ (where gᵢⱼ is an element of G) associated with two beams (301 and 302). It will be appreciated that the first beam 301 would be represented by a first node vᵢ in a graph representation and the second beam 302 would be represented by a second node vⱼ in a graph representation. FIG. 3 depicts the coverage of a first beam 301 originating from a network node 303, and the coverage of the second beam 302 originating from a network node 304. The hashed area 305 indicates the overlap between the radio coverage areas of the beams 301 and 302.

The set of geometric features gᵢⱼ comprises a spatial configuration of the overlap between the respective radio coverage areas associated with an edge. In some embodiments, the set of geometric features gᵢⱼ associated with an edge may comprise an interference area (IA). For example, the IA may be expressed in terms of an amount of area that comprised in the overlap between the radio coverage areas 305.

In some embodiments, the set of geometric features may comprise an interference centric (IC), wherein the IC comprises a centre of the IA. The IC may be determined by averaging across coordinates of the IA. FIG. 3 depicts the IC as a cross located at a central position within the IA. In some embodiments, the set of geometric features may comprise at least one interference distance (ID), wherein the ID is the distance from a network node providing a radio coverage area to the IC. It will be appreciated that the set of geometric features gᵢⱼ may comprise two IDs, a first ID₁ associated with a source node (e.g. 302) of the edge and a second ID₂ associated with a destination node (e.g. 301) of the edge.

It will be appreciated that the ID₁ associated with the source node of the edge is not necessarily equal to the ID₂ associated with the destination node of the edge

As will be described in more detail with reference to step 103 of FIG. 1, the sets of geometric features, G, are used as a label for each edge in the graph representation.

The sets of geometric features, G, may be determined from configuration management (CM) parameters obtained from the set of nodes. The CM parameters may comprise the node attributes X as described above.

For example, the CM parameters may indicate a beam width and a beam direction for a particular node in the network. From this information it may be determinable where the overlap between radio coverage areas will occur. This information may then be utilised to determine the sets of geometric features, G.

It will therefore be appreciated that in some examples the method of FIG. 1 may further comprise obtaining first training CM parameters from the set of nodes. In some examples the method of FIG. 1 then further comprises determining the one or more sets of geometric features from the first training CM parameters. The training CM parameters may comprise configurations of the set of nodes in training data for the network. The training CM parameters may comprise one or more of: a beamwidth, a Maximum Transmission Power, a MIMO scheme, an Antenna Height, an Antenna Orientation, an Antenna Electrical tilt, an Antenna mechanical tilt, a Sector Id, a Carrier frequency, a Downlink/Uplink earfcn number.

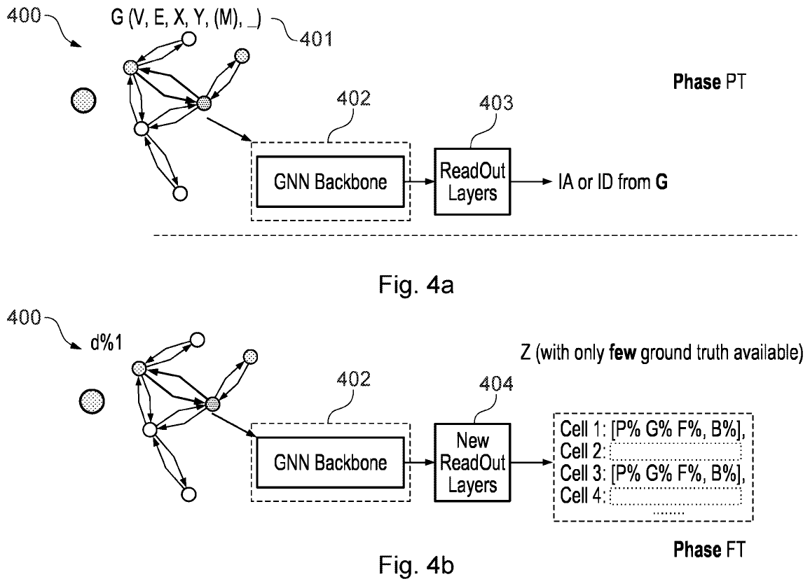

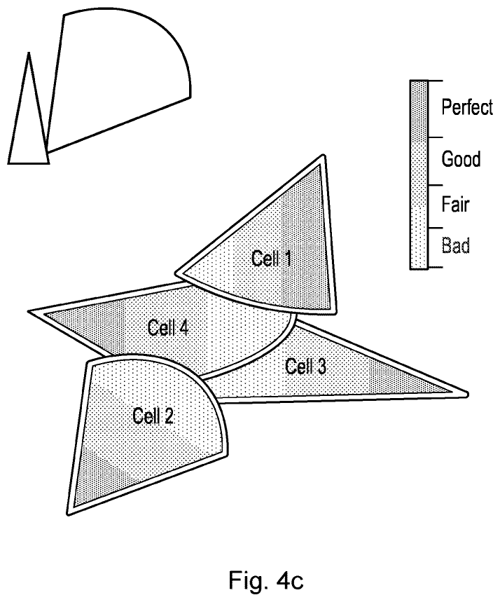

In step 103, a first phase of training of the GNN model is conducted using one or more first output layers of the GNN model. In other words, during the first phase of training the GNN model is constructed with one or more first output layers. In particular, as will be later described with reference to FIG. 4a, the one or more output layers may be configured to output predictions of the sets of geometric features, G.

The first phase of training therefore comprises training the GNN model to predict the sets of geometric features. To perform the first phase of training first training CM parameters may be obtained that comprise CM parameters of the network represented by the GNN.

Step 103 may then comprise inputting the first training CM parameters into the GNN model.

FIG. 4a illustrates the structure of the GNN during the first phase of training of the GNN model. The schematic 400 depicts an example of a graph representation that may be obtained as described with reference to step 101.

It will be appreciated that a GNN model comprises a neural network having a plurality of layers. The plurality of layers comprise a backbone 402, wherein the backbone 402 comprises one or more first input layers of the GNN model. The backbone 402 may further comprise weights between the one or more first input layers of the GNN model. In some examples, the backbone 402 further comprises one or more second input layers.

The GNN model may further comprise one or more first output layers 403. The one or more first output layers 403 may further comprise weights between the one or more first output layers of the GNN model. The backbone 402 and the one or more first output layers 403 may also be connected by weights.

During the first phase of training, the obtained sets of geometric features (e.g. as obtained in step 101) may be assigned as a label for each edge in the GNN model. The first one or more output layers 403 of the GNN model may be used to obtain a first output of the GNN model. Whilst utilising the first one or more output layers 403, the first output of the GNN model comprises predicted sets of geometric features, G_{pred}.

Step 103 may then comprise adjusting one or more second parameters of the GNN model associated with the one or more first input layers of the GNN model to reduce the value of a first loss function. It will be appreciated that the first loss function may be determined from a comparison between the predicted sets of geometric features and the actual sets of geometric features, G. For example, the first loss function may comprise a mean squared error between the predicted sets of geometric features, G_{pred} and the obtained sets of geometric features, G.

In some embodiments, the one or more second parameters of the GNN model to be adjusted comprise the weights of the backbone 402 (e.g. the one or more first input layers comprise the entire backbone 402). However, in some examples, not all of the backbone 402 weights are adjusted during the first phase of training.

It will be appreciated during training of the GNN model predictions may be performed iteratively (e.g. with different training data comprising different training CM parameters) until the value of the loss function converges to a local or global minimum. The weights of the one or more first input layers may be adjusted after the GNN model performs each prediction. It will be appreciated that not the weights of the one or more first input layers will be adjusted during each iteration of the first phase of training. However, the weights of the one or more first input layers may be considered available to be adjusted during each iteration of the second phase of training.

At step 104, at least one first parameter of the GNN model is selected to be fixed. Step 104 may comprise selecting the one or more second parameters (e.g. those adjusted in step 103) as the at least one first parameter. In some embodiments, the at least one first parameter of the GNN model that is selected to be fixed comprises the weights of the backbone 402. However, in some examples not all weights of the backbone 402 are fixed.

FIG. 4b illustrates an example of the structure of the GNN during the second phase of training of the GNN model. In this example, the weights of the GNN backbone 402 are fixed in step 104.

At step 105, a second phase of training of the GNN model is conducted using one or more second output layers 404 in the GNN model to predict performance metrics associated with the set of nodes. In other words, after performing the first phase of training in step 103, the one or more first output layers 403 are replaced with one or more second output layers 404. The second output layers 404 are configured to output predictions of performance metrics associated with the set of nodes. For example, the second output layers 404 may be configured to output predictions of performance management data.

FIG. 4c is a diagram representing Quality of Service Key Performance Indicators (QoS KPI) values associated with four radio coverage areas, wherein the QoS KPI values comprise a range from Bad to Perfect. The diagram illustrates that in regions of low interference the QoS KPI values are towards the Perfect end of the scale and in regions of high interference the QoS KPI values are towards the Bad end of the scale. One example of performance management data may comprise percentages of a radio coverage area that is associated with Bad, Fair, Good or Perfect QoS KPI values.

The one or more second output layers 404 may further comprise weights between the one or more second output layers.

The second phase of training further comprises obtaining performance management (PM) data of radio coverage areas of a network. Herein PM data may be considered equivalent to performance metrics. The PM data may be obtained using a similar method to the method used to obtain CM data, wherein the PM data of radio coverage areas of interest is collected in a message queue (MQ) for the node performing NDO. The node performing NDO may subscribe to the PM data of a radio coverage area by transmitting an identifier or a unique fingerprint that identifies the radio coverage area in a network topology. In some embodiments, the identifier may comprise MCC, MNC, LAC or Cell ID coordinates. In some embodiments, the PM data comprises QoS KPIs. The PM data may be obtained from a subset of the radio coverage areas in the network. In some embodiments, the subset may comprise X % of the total number of radio coverage areas in the network. In some embodiments, the subset may comprise only 2.5% of the total number of radio coverage areas. In some embodiments, the PM data is obtained by executing a road test. In other embodiments, the PM data is obtained by triggering measurement reports of wireless devices in the subset of radio coverage areas.

In some examples, the second phase of training further comprises assigning the obtained performance metrics (e.g. PM data) of the subset of radio coverage areas in the network as labels for the nodes in the graph representation. The obtained performance metrics from the subset of radio coverage areas may be used as ground truth for the GNN model.

The second output layers of the GNN model may be used to obtain a second output of the GNN model. In some embodiments, the second output of the GNN model may comprise predicted performance metrics for the nodes in the graph representation.

It will be appreciated that step 105 comprises training the GNN model with the at least one first parameter (selected in step 104) fixed.

As previously described, in some examples, the first parameter to be fixed comprises the weights of the backbone 402 of the GNN model. In these examples, during the second phase of training the weights between the one or more second output layers are adjusted. However, in some examples, not all weights of the backbone 402 are fixed (e.g. the backbone 402 comprises one or more first input layers and one or more second input layers). In these examples, the second phase of training may further comprise adjusting the weights of the one or more second input layers.

In other words, step 105 may further comprise adjusting one or more third parameters of the GNN model to reduce a value of a second loss function. It will be appreciated that the second loss function may be determined from a comparison between the predicted performance metrics and the labelled performance metrics. For example, the second loss function may comprise a mean squared error between the predicted performance metrics and the labelled performance metrics.

In some embodiments, the one or more third parameters adjusted during the second phase of training comprises one or more of one or more parameters associated with the one or more second output layers and one or more parameters associated with the one or more second input layers.

It will be appreciated that the second phase of training may be performed iteratively using the performance metrics obtained from the network until the value of the second loss function converges to a local or global minimum. The one or more third parameters may be adjusted after the GNN model performs each prediction. It will be appreciated that not all of the one or more third parameters will be adjusted during each iteration of the second phase of training. However, the one or more third parameters may be considered available to be adjusted during each iteration of the second phase of training.

After step 105 has been completed, the second phase of training the GNN model may be considered completed. The time of the second phase of training may comprise in the range of hours.

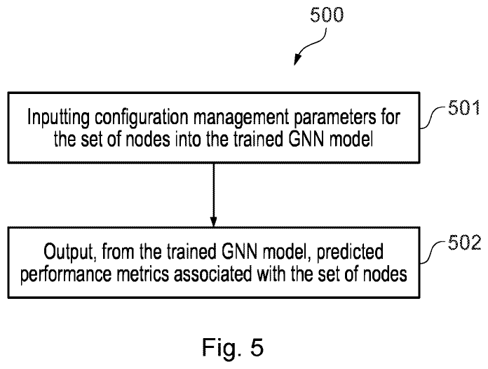

FIG. 5 depicts a method 500 for implementing an inference phase of the GNN model, wherein the inference phase comprises using GNN model (that may be trained as described with reference to FIGS. 1 to 4) to obtain predictions of performance metrics of radio coverage areas. It will be appreciated that the input to the GNN model may comprise combinations of CM data at the nodes of the GNN that was not used during the training phases of the GNN model.

It will be appreciated that the input CM data may effectively alter the node attributes and the edge attributes of the graph representation in the GNN model.

At step 501, CM data associated with the one or more nodes is input into the trained GNN model. The CM data may alter the node attributes and or edge attributes within the graph representation. The graph representation may also comprise sets of geometric features determined from the CM data. The trained GNN model may then output predictions of performance metrics of the nodes. Using the trained GNN model to predict the performance metrics models the prediction as a node attribute prediction task, wherein the expressiveness of the GNN model architecture considerably improves the performance metric prediction.

At step 502, the trained GNN model outputs one or more predictions of the performance metrics for the one or more nodes. In some embodiments, the predicted performance metrics may comprise QoS KPIs. The time of the inference phase may comprise only in the range of a few seconds.

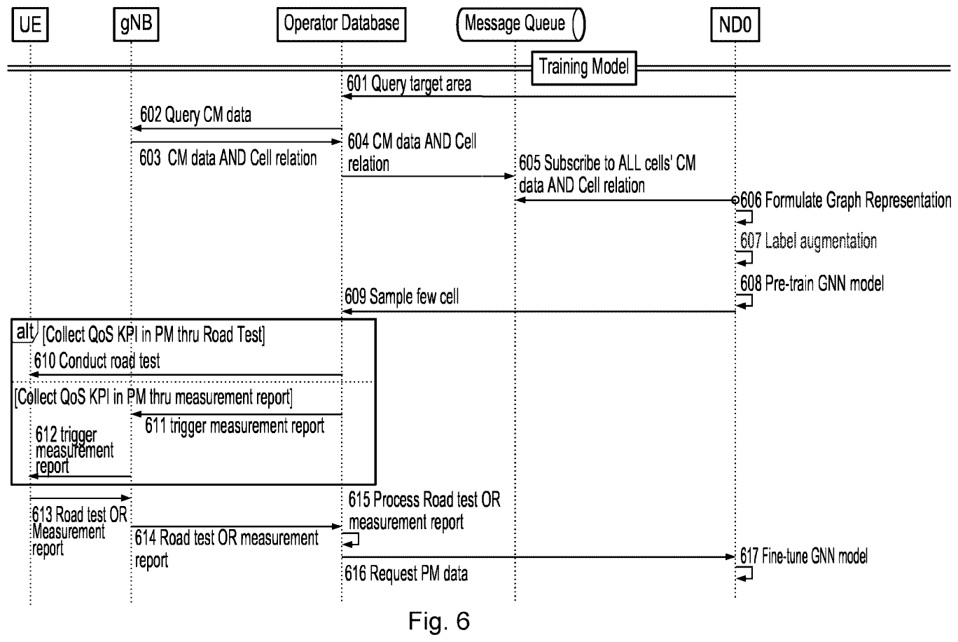

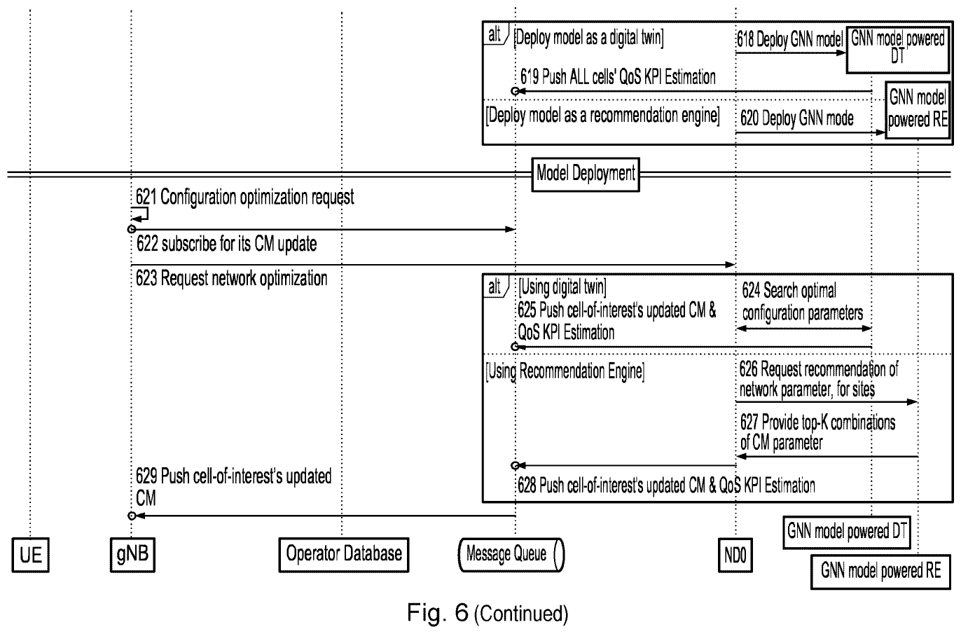

The deployment (or inference) phase may be implemented using, for example, two different deployment solutions of the trained GNN model. For example, the deployment phase may comprise using the trained GNN model as a Digital Twin (DT) or using the trained GNN model as a Recommendation Engine (RE). It will be appreciated, as will be described later with reference to FIG. 6, that for deployment solutions wherein the trained GNN model is used as a DT for the network, the trained GNN model may be used for searching for CM parameters that provide optimal performance metrics for a requesting cell. It will also be appreciated, as will be described later with reference to FIG. 6, that for deployment solutions wherein the trained GNN model is used as a RE, the trained GNN model may offer CM recommendations to a requesting cell.

FIG. 6 is a signalling diagram illustrating an example implementation of the methods of FIGS. 1 and 5. In this example, the methods of FIGS. 1 and 5 are performed by a node performing network design and optimisation (NDO) for a network (e.g. a cellular network).

The example implementation begins at step 601, wherein the node performing NDO queries an Operator Database (which may be located in any suitable node that interacts with the network) for a target area, for example, by using latitude and longitude coordinates or by using a series of identifiers that identify the coverage areas. The identifiers may comprise MCC, MNC, LAC or Cell ID coordinates. At step 602, the Operator Database queries at least one gNB for configuration management (CM) data for radio coverage areas in the target area or radio coverage areas in an identifier series.

In step 603, the gNB forwards the CM data and information of inter-cell relations to the Operator Database. The information of the inter-cell relations may comprise one or more of an inter-cell distance, a relation type and a relation strength. The inter-cell distance may comprise the geographical distance between one cell in the network and another cell in the network. The relation type may comprise information describing if the coverage area of one cell is one of interfering or complementing or both of the coverage area of another cell. The relation strength may comprise the size of the impact that the coverage area of one cell may have on the coverage area of another cell.

At step 604, the Operator Database forwards the CM data and the information of the inter-cell relations to the Message Queue (MQ). At step 605, the node performing NDO subscribes to the CM data and the inter-cell relations information of all the cells by their identifiers, wherein the identifiers may comprise MCC, MNC, LAC or Cell ID coordinates.

At step 606, the node performing NDO formulates a graph representation according to the information from each cell. Step 606 comprises an example implementation of step 101 of FIG. 1.

At step 607, the node performing NDO may obtain a set of geometric features, G, by augmenting the and edge attributes for the graph representation. Step 607 comprises an example implementation of step 102 of FIG. 1.

At step 608, the node performing NDO pre-trains a GNN model. Pre-training the GNN model comprises conducting a first phase of training of the GNN model. Step 608 comprises an example implementation of step 103 of FIG. 1.

At step 609, the node performing NDO samples a subset of the radio coverage areas in the network and requests from the Operator Database the performance metrics (e.g. PM data) associated with the subset of the radio coverage areas. As previously described, the performance metrics may comprise QoS KPIs. The node performing NDO may request the performance metrics by utilising a unique fingerprint or identifier associated with each radio coverage area. An identifier associated with a radio coverage area may comprise MCC, MNC, LAC or Cell ID coordinates. The node performing NDO may sample X % of the PM data of all of the radio coverage areas. In some embodiments, the node performing NDO may sample only 2.5% of the PM data of all of the radio coverage areas. It will be appreciated that, as the node performing NDO only needs to sample a portion (e.g. only 2.5%) of the PM data of all of the radio coverage areas in order to perform the second phase of training, this reduces the need for conducting excess road tests and UE measurement reports, which reduces the operational cost of the NDO.

Steps 610 through to 616, illustrate how information on the performance metrics (e.g. PM data) of the subset of the cells may be obtained for forwarding to the node performing NDO.

In one embodiment, the PM data may be collected using a road test. At step 610, the Operator Database instructs a wireless device (e.g. a user equipment UE) to conduct the road test, wherein the road test is a method performed by the wireless device for measuring and assessing the radio coverage of a network. Road test measurements may be collected at a small scale due to the high operational cost.

In another embodiment, the PM data may be collected using a measurement report of the UEs in the subset of cells. At step 611, the Operator Database instructs the gNB to trigger a UE measurement report. At step 612, the gNB instructs the UE to trigger a measurement report.

In step 613, the UE forwards the road test or the measurement report to the gNB. At step 614, the gNB forwards the road test or the measurement report to the Operator Database. At step 615, the Operator Database processes the road test or the measurement report to obtain PM data. The PM data may comprise QoS KPIs. At step 616, the Operator Database forwards the requested PM data to the node performing NDO.

At step 617, the node performing NDO fine-tunes the GNN model, wherein the step of fine-tuning the GNN model comprises fixing at least one first parameter of the GNN model and conducting a second phase of training of the GNN model. Step 617 comprises an example implementation of steps 104 and 105 of FIG. 1. It will be appreciated that the PM data received in step 616 may be used as ground truth data for step 617.

The trained GNN model may enter the deployment phase after the second phase of training is complete.

In one deployment solution, the trained GNN model is deployed to power a Digital Twin (DT). For this solution the steps 618, 619, 621 to 625 will be performed.

At step 618, the node performing NDO deploys the trained GNN model to power a DT of the network topology. The deployment comprises the DT obtaining current CM parameters (e.g. current CM data) of one or more radio coverage areas for input into the trained GNN model. Step 618 comprises an example implementation of step 501 of FIG. 5. The DT may obtain current CM data using a method according to steps 601 to 605. The current CM data associated with the one or more radio coverage areas is input into the DT.

At step 619, the DT uses the current CM data of the radio coverage areas to output an inference result, wherein the inference result comprises current predicted performance metrics of the radio coverage areas. The current predicted performance metrics may comprise predicted QoS KPIs. The DT then transmits the inference result of step 619 to the MQ. Step 619 comprises an example implementation of step 502 of FIG. 5. The step of the DT transmitting the current predicted performance metrics to the MQ also comprises referencing the identifiers of the radio coverage areas, wherein the identifiers may comprise MCC, MNC, LAC or Cell ID coordinates. Step 619 may further comprise indicating the current CM data for the radio coverage areas to the MQ, wherein the CM data may be continuously updated once a new CM parameter value is applied at a radio coverage area.

At step 621, a gNB raises a configuration optimization request, wherein the gNB requests a parameter fine-tuning. At step 622, the gNB subscribes to the MQ to receive any updates of CM data that correspond to identifiers of radio coverage areas provided by the gNB. It will be appreciated that step 622 may occur concurrently with step 621. At step 623, the gNB transmits a request for network optimization to the node performing NDO along with identifiers of radio coverage areas provided by the gNB and, in some examples, the identifiers of its neighbouring radio coverage areas. It will be appreciated that the node performing NDO may acknowledge the request raised by the gNB.

At step 624, the node performing NDO searches for recommended CM parameters for the gNB using the performance metrics predicted by the DT as a fitness metric. In other words, the node performing NDO may utilise the GNN model powered DT to search for recommended CM parameters that provide at least some improvement to the predicted performance metrics when compared to the current performance metrics predicted in step 619. It will be appreciated that the GNN model may be limited to comprise nodes representing those radio coverage areas identified in step 623 (e.g. that of the gNB and the neighbouring radio coverage areas).

Step 624 may comprise the node performing NDO evaluating the effect on predicted performance metrics that different candidate CM parameter combinations have in the DT. Step 624 may therefore comprise an example implementation of steps 501 and 502 of FIG. 5. In some examples, the recommended CM parameters comprise the candidate CM parameters combination that provided optimal predicted performance metrics from the DT. The search for the recommended CM parameters by the node performing NDO may be automated by using one or more of a searching algorithm, reinforcement learning models and/or manual configuration by a human expert.

At step 625, the node performing NDO confirms the selected recommended CM parameters determined by the DT. The DT may then transmit an indication of the recommended CM parameters (and the estimation of the performance metrics that will result from the recommended CM parameters) to the MQ wherein the recommended CM parameters are associated with radio coverage identifiers (e.g. MCC, MNC, LAC or Cell ID coordinates). The gNB may then receive the recommended CM parameters due to its subscription (e.g. step 622) to the MQ. The DT deployment solution may therefore enable the gNB to receive recommended CM parameters that may enable it to at least improve on the performance metrics being achieved at the gNB.

In a second deployment solution, the trained GNN model is deployed to power a RE. In this example, the steps 620 to 623 and 626 to 629 are performed.

At step 620, the node performing NDO deploys the trained GNN model to power a RE for CM parameters.

At step 621, a gNB raises a configuration optimization request, wherein the gNB requests a parameter fine-tuning. At step 622, the gNB subscribes to the MQ to receive any updates of CM data that correspond to identifiers of radio coverage areas provided by the gNB. It will be appreciated that step 622 may occur concurrently with step 621. At step 623, the gNB transmits a request for network optimization to the node performing NDO along with identifiers of radio coverage areas provided by the gNB and, in some examples, the identifiers of its neighbouring radio coverage areas. It will be appreciated that the node performing NDO may acknowledge the request raised by the gNB.

At step 626, the node performing NDO transmits, to the GNN model powered RE, a request for recommended CM parameters for the radio coverage areas identified by the gNB in step 623. The RE retrieves the identifier of each radio coverage area identified in the request and finds radio coverage areas that are similar to the requesting radio coverage area. The RE may find similar radio coverage areas by calculating the pair-wise similarity between the radio coverage areas represented in the GNN model and the requesting radio coverage area. It will be appreciated that the GNN model may be limited to comprise nodes representing those radio coverage areas identified in step 623 (e.g. that of the gNB and the neighbouring radio coverage areas).

The calculation of the pair-wise similarity between radio coverage areas may comprise calculating the cosine similarity between radio coverage areas.

The RE may then take candidate CM parameters as the current CM parameters of the X (where X is an integer number) most similar radio coverage areas. These candidate CM parameters may be each used in turn as an input for the CM parameters for the requesting radio coverage area in the GNN model, which may then output a prediction of the performance metrics for the requesting radio coverage area as a result of each candidate CM parameters. It will be appreciated that this step may comprise an example implementation of step 502 of FIG. 5. The candidate CM parameters may then be ranked according to their resulting predicted performance metrics for the requesting radio coverage area. The RE may then select one or more candidate CM parameters that have the highest-ranking performance metrics.

At step 627, the RE offers the one or more selected candidate CM parameters as a recommendation for the requesting cell to the node performing NDO. At step 628, the node performing NDO transmits the one or more selected candidate CM parameters (optionally along with their associated estimated performance metrics for the requesting radio coverage area) to the MQ along with an identifier for the radio coverage area. At step 629, the MQ transmits the selected candidate CM parameters to the gNB. The gNB may then opt to adopt one of the selected candidate CM parameters in order to improve the performance metrics at the gNB.

The text in italics below comprises an example of pseudocode that may be utilised the implement the signalling diagram of FIG. 6.

```
@startuml
autonumber
participant “UE”
participant gNB
participant “Operator Database”
queue “Message Queue”
participant “NDO”
== Training Model ==
NDO −> “Operator Database” : Query target area by: [Latitude, Longitude], OR by a
series of identifiers: [MCC,MNC,LAC,Cell ID]
“Operator Database” −> gNB : Query CM data for cells in the interested area, OR in
identifier series.
gNB −> “Operator Database” : CM data AND Cell relation [Inter-cell distance, relation
type, relation strength]
“Operator Database” −> “Message Queue”: CM data AND Cell relation
NDO o−> “Message Queue” : Subscribe to ALL cells' CM data AND Cell relation by their
identifiers: [MCC,MNC,LAC,Cell ID]
NDO −[#red]> NDO : Formulate Graph Representation
NDO −[#red]> NDO : Label augmentation
NDO −[#red]> NDO : Pre-train GNN model
NDO −> “Operator Database”: Sample few cell, request their QoS KPI from PM data
alt Collect QoS KPI in PM thru Road Test
      “Operator Database” −> UE: Conduct road test
else Collect QoS KPI in PM thru measurement report
      “Operator Database”−> gNB : trigger measurement report
      gNB −> UE : trigger measurement report
end
UE −> gNB : Road test OR measurement report
gNB −> “Operator Database”: Road test OR measurement report
“Operator Database” −> “Operator Database”: Process Road test OR measurement
report into QoS KPI in PM
“Operator Database”−> NDO: Requested PM data
NDO −[#red]> NDO : Fine-tune GNN model
alt Deploy model as a digital twin
  create “GNN model powered DT”
  NDO −[#red]> “GNN model powered DT” : Deploy GNN model
  “GNN model powered DT” −>o “Message Queue” : Push ALL cells'QoS KPI Estimation
by identifiers [MCC,MNC,LAC,Cell ID]
else Deploy model as a recommendation engine
  create “GNN model powered RE”
  NDO −[#red]> “GNN model powered RE” : Deploy GNN mode
end
== Model Deployment ==
gNB −> gNB: Configuration optimization request
qNB o−> “Message Queue”: subscribe for its CM update by identifier
gNB −> NDO: Request network optimization
alt Using digital twin
      NDO <−> “GNN model powered DT” : Search optimal
configuration parameters by human expert or search algorithm
      “GNN model powered DT” −>o “Message Queue” : Push cell-
of-interest's updated CM & QoS KPI Estimation by their identifiers: [MCC,MNC,LAC,Cell
ID]
else Using Recommendation Engine
      NDO −> “GNN model powered RE” : Request recommendation
of network parameter, for sites by their identifiers: [MCC,MNC,LAC,Cell ID]
    “GNN model powered RE” −> NDO : Provide top-K combinations of CM parameter by
recommendations
      “NDO” −>o “Message Queue” : Push cell-of-interest's updated
CM & QoS KPI Estimation by their identifiers: [MCC,MNC,LAC,Cell ID]
end
“Message Queue” −>o gNB : Push cell-of-interest's updated CM
@enduml
```

Table 1 presents some results from an experimental evaluation of the proposed embodiments.

TABLE 1
Results from an experimental evaluation of the proposed embodiments

| Model | KPI | CPH | CPH(w.G) | A + A | A + A(w.G) |
|---|---|---|---|---|---|
| GAT | SINR | 5.7 ± 0.5% | 5.6 ± 0.5% | 5.6 ± 0.2% | 5.6 ± 0.1% |
| WCGCN | SINR | 3.2 ± 0.7% | 3.1 ± 0.3% | 1.1 ± 0.1% | 1.1 ± 0.2% |
| GINE | SINR | 3.4 ± 0.3% | 3.5 ± 0.4% | 2.0 ± 0.1% | 1.8 ± 0.2% |
| MLP | SINR | 5.5 ± 0.1% | 5.5 ± 0.1% | 5.5 ± 0.1% | 5.5 ± 0.1% |
| GAT | CQI | 0.31 ± 0.1% | 0.30 ± 0.1% | 2.9 ± 0.1% | 2.9 ± 0.1% |
| WCGCN | CQI | 0.24 ± 0.2% | 0.24 ± 0.1% | 1.3 ± 0.2% | 1.2 ± 0.2% |
| GINE | CQI | 0.28 ± 0.2% | 0.26 ± 0.1% | 1.7 ± 0.1% | 1.6 ± 0.2% |
| MLP | CQI | 0.3 ± 0.1% | 0.29 ± 0.1% | 3.1 ± 0.1% | 3.1 ± 0.1% |

In this evaluation we included network configurations crawled from real networks. The datasets pose a diverse and unbalanced feature distribution as each set of configuration parameters is fine-tuned by human experts. Furthermore, we evaluated the proposed method against many state-of-the-art models that are reported to be leading in coverage QoS KPI estimation task: Graph Attention Q-Learning (GAQ)/Graph Attention Networks (GAT), Graph Isomorphism Network with Edge feature (GINE), Wireless Channel Graph Convolution Network (WCGCN) and Multi-Layer Perceptron (MLP).

The GNN model in this evaluation was trained against real network configurations in two geographical locations, i.e., Copenhagen (CPH) and Aalborg-Aarhus (A+A). Each geographical location comprises more than a total of 1600 radio cells and 10800 ‘inter-cell’ relations. The network measurement and KPIs are obtained from simulation in Info-Vista Planet.

First the state-of-the-art performance of GNNs in a transudative setting is compared with an ablation study against G as an additional node feature. The result in mean squared error (MSE) (%) is presented in Table 1. For a generalization setting, we denote X→Y as training on dataset X and testing the GNN model performance on dataset Y to verify the model's generalization ability across different scenarios. The generalization performance is shown in Table 2.

TABLE 2
Generalisation Performance

| Model | KPI | CPH → A + A | CPH → A + A (w.G) | A + A → CPH | A + A → CPH (w.G) |
|---|---|---|---|---|---|
| GAT | SINR | 9.2 ± 0.2% | 9.35 ± 0.3% | 11.3 ± 0.8% | 11.2 ± 0.7% |
| WCGCN | SINR | 9.5 ± 0.3% | 9.4 ± 1.7% | 11.6 ± 0.3% | 8.7 ± 0.3% |
| GINE | SINR | 9.4 ± 2.0% | 11.5 ± 4.2% | 12.3 ± 3.0% | 8.7 ± 0.2% |
| MLP | SINR | 12.0 ± 0.2% | 12.1 ± 0.9% | 10.9 ± 0.7% | 10.9 ± 0.7% |
| GAT | CQI | 3.7 ± 0.2% | 3.5 ± 0.8% | 0.39 ± 0.1% | 0.45 ± 0.7% |
| WCGCN | CQI | 4.3 ± 0.1% | 4.05 ± 0.0% | 0.34 ± 0.2% | 0.52 ± 0.3% |
| GINE | CQI | 3.8 ± 0.7% | 4.9 ± 2.9% | 0.52 ± 0.4% | 1.13 ± 0.9% |
| MLP | CQI | 3.5 ± 0.4% | 3.5 ± 0.4% | 0.88 ± 0.4% | 0.88 ± 0.4% |

Given presented results presented in Tables 1 and 2, it may be concluded that, for Table 1: (i) WCGCN outperforms most benchmark models when given sufficient measurement on QoS KPI, while GAT has almost equivalent performance to MLP. (ii) Comparing the performance between ‘with’ and ‘without’ G as additional edge attribute in Table II, we observe that the augmented geometric feature does not improve transductive performance when there is sufficient ground truth available. (iii) Comparing the respective cells between Table II and III, we observe that the GNN model cannot generalize its performance to a new area, without degradation.

However, table 3 illustrates a comparison between the best performing model in Few-Shot Learning (FSL) (e.g. with only 2.5% ground truth but utilising the embodiments described herein) with the performance in full training in table 3 where ‘SOTA’ (State of the Art) denotes a full training using 80% of ground truth.

TABLE 3
Comparison between the best performing model
in FSL with the performance in full training.

| Dataset | KPI | α % | Best Model | G | FSL MSE(%) | SOTA MSE(%) | Gap |
|---|---|---|---|---|---|---|---|
| CPH | SINR | 2.5% | WCGCN | IA | 6.0 ± 0.2% | 4.0 ± 0.2% | −2.0% |
| | | 2.5% | GINE | ID | 6.0 ± 0.2% | 4.3 ± 0.2% | −1.7% |
| CPH | CQI | 2.5% | GINE | IA | 0.30 ± 0.0% | 0.8 ± 0.3% | 0.5% |
| A + A | SINR | 2.5% | GINE | ID | 5.9 ± 0.1% | 5.6 ± 0.1% | −0.3% |
| A + A | CQI | 2.5% | GINE | ID | 2.8 ± 0.0% | 2.8 ± 0.1% | 0 |

It can be concluded from table 3 that embodiments described herein utilising only 2.5% ground truth data can compete with ‘SOTA’ training in many downstream tasks. It will be appreciated that the two stages of training the GNN model enables the GNN model to learn network geometry knowledge, which enables it to outperform the state-of-the-art training framework.

The results below indicate an averaged result of all valid radio coverage areas for the two trained datasets, respectively for each target KPI to predict against. These results are ordered as follows: [Dataset] [KPI]: [Perfect %, Good %, Fair %, Bad %]
CPH CQI [79.79069682, 15.20688252, 4.68468991, 0.31773075]
CPH SINR [57.99379407, 38.3568345, 0.08869052, 3.5606809]
A+A CQI [56.0776328, 16.60786248, 17.94046752, 9.37403719]
A+A SINR [7.88520738e+01, 2.03728532e+01, 7.50640022e-01, 2.44330202e-02]

It can be seen from the able that the percentage of “Bad” coverage is very nearly eliminated by the implementation of embodiments described herein.

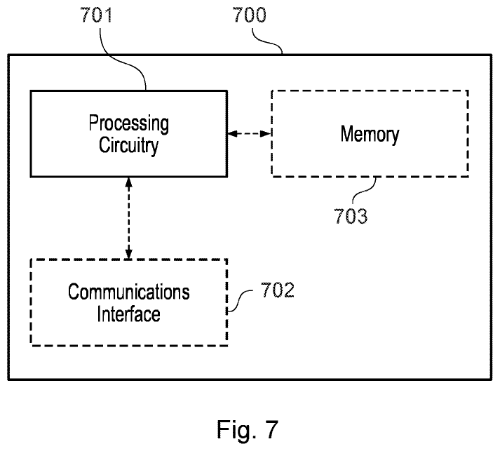

FIG. 7 illustrates an apparatus 700 comprising processing circuitry (or logic) 701. The processing circuitry 701 controls the operation of the apparatus 700 and can implement the method described herein in relation to an apparatus 700. The processing circuitry 701 can comprise one or more processors, processing units, multi-core processors or modules that are configured or programmed to control the apparatus 700 in the manner described herein. In particular implementations, the processing circuitry 701 can comprise a plurality of software and/or hardware modules that are each configured to perform, or are for performing, individual or multiple steps of the method described herein in relation to the apparatus 700. It will be appreciated that the apparatus 700 may comprise one or more virtual machines running different software and/or processes. The apparatus 700 may therefore comprise, or be implemented in or as one or more servers, switches and/or storage devices and/or may comprise cloud computing infrastructure that runs the software and/or processes.

Briefly, the processing circuitry 701 of the apparatus 700 is configured to: obtain a graph representation of a network, wherein the graph representation comprises: a set of nodes, V, wherein each node represents a radio coverage area; and a set of edges, E, wherein each edge connects two nodes in the set of nodes and represents a relationship between the two nodes; obtain sets of geometric features, G, associated with overlaps between respective radio coverage areas associated with at least some edges in the set of edges; conduct a first phase of training using one or more first output layers for the GNN model, wherein the first phase of training comprises training the GNN model to predict the sets of geometric features; after the first phase of training, select at least one first parameter of the GNN model to fix; and conduct a second phase of training using one or more second output layers in the GNN model to predict performance metrics associated with the set of nodes, wherein the second phase of training comprises training the GNN model with the at least one first parameter fixed.

In some embodiments, the apparatus 700 may optionally comprise a communications interface 702. The communications interface 702 of the apparatus 700 can be for use in communicating with other nodes, such as other virtual nodes. For example, the communications interface 702 of the apparatus 700 can be configured to transmit to and/or receive from other nodes requests, resources, information, data, signals, or similar. The processing circuitry 701 of apparatus 700 may be configured to control the communications interface 702 of the apparatus 700 to transmit to and/or receive from other nodes requests, resources, information, data, signals, or similar. The communications interface 702 can use any suitable communication technology.

Optionally, the apparatus 700 may comprise a memory 703. In some embodiments, the memory 703 of the apparatus 700 can be configured to store program code that can be executed by the processing circuitry 701 of the apparatus 700 to perform the method described herein in relation to the apparatus 700. Alternatively, or in addition, the memory 703 of the apparatus 700, can be configured to store any requests, resources, information, data, signals, or similar that are described herein. The processing circuitry 701 of the apparatus 700 may be configured to control the memory 703 of the apparatus 700 to store any requests, resources, information, data, signals, or similar that are described herein. The apparatus 700 may be configured operate in the manner described herein in respect of an apparatus.

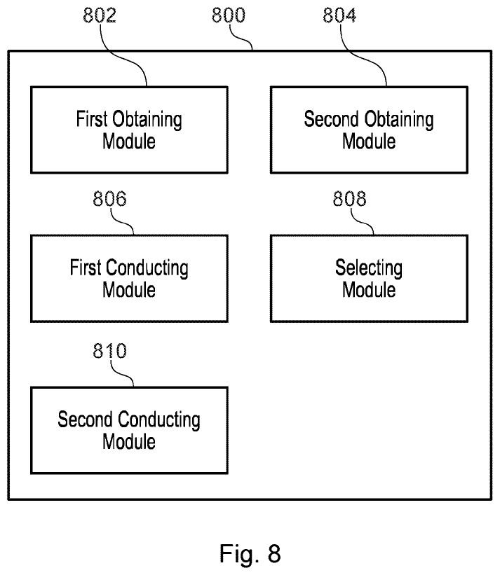

FIG. 8 is a block diagram illustrating an apparatus 800 according to some embodiments. The apparatus 800 comprises a first obtaining module 802 configured to obtain a graph representation of a network, wherein the graph representation comprises: a set of nodes, V, wherein each node represents a radio coverage area; and a set of edges, E, wherein each edge connects two nodes in the set of nodes and represents a relationship between the two nodes. The apparatus 800 further comprises a second obtaining module 804 configured to obtain sets of geometric features, G, associated with overlaps between respective radio coverage areas associated with at least some edges in the set of edges. The apparatus 800 further comprises a first conducting module 806 configured to conduct a first phase of training using one or more first output layers for the GNN model, wherein the first phase of training comprises training the GNN model to predict the sets of geometric features. The apparatus 800 further comprises a selecting module 810 configured to after the first phase of training, select at least one first parameter of the GNN model to fix. The apparatus 800 further comprises a second conducting module 812 configured to conduct a second phase of training using one or more second output layers in the GNN model to predict performance metrics associated with the set of nodes, wherein the second phase of training comprises training the GNN model with the at least one first parameter fixed.

The apparatus 800 may operate in the manner described herein in respect of an apparatus.

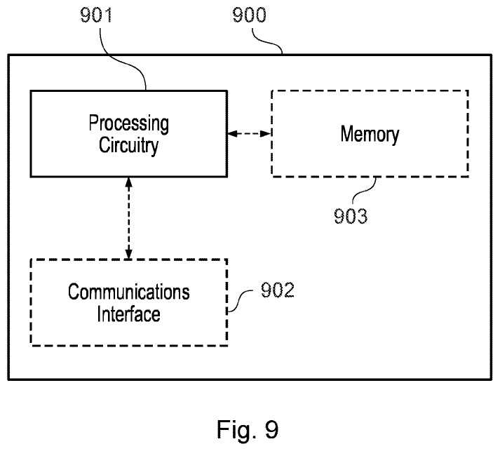

FIG. 9 illustrates an apparatus 900 comprising processing circuitry (or logic) 901. The processing circuitry 901 controls the operation of the apparatus 900 and can implement the method described herein in relation to an apparatus 900. The processing circuitry 901 can comprise one or more processors, processing units, multi-core processors or modules that are configured or programmed to control the apparatus 900 in the manner described herein. In particular implementations, the processing circuitry 901 can comprise a plurality of software and/or hardware modules that are each configured to perform, or are for performing, individual or multiple steps of the method described herein in relation to the apparatus 900. It will be appreciated that the apparatus 900 may comprise one or more virtual machines running different software and/or processes. The apparatus 900 may therefore comprise, or be implemented in or as one or more servers, switches and/or storage devices and/or may comprise cloud computing infrastructure that runs the software and/or processes.

Briefly, the processing circuitry 901 of the apparatus 900 is configured to use a GNN model wherein the GNN model is trained as described in any of the embodiments herein.

In some embodiments, the apparatus 900 may optionally comprise a communications interface 902. The communications interface 902 of the apparatus 900 can be for use in communicating with other nodes, such as other virtual nodes. For example, the communications interface 902 of the apparatus 900 can be configured to transmit to and/or receive from other nodes requests, resources, information, data, signals, or similar. The processing circuitry 901 of apparatus 900 may be configured to control the communications interface 902 of the apparatus 900 to transmit to and/or receive from other nodes requests, resources, information, data, signals, or similar. The communications interface 902 can use any suitable communication technology.

Optionally, the apparatus 900 may comprise a memory 903. In some embodiments, the memory 903 of the apparatus 900 can be configured to store program code that can be executed by the processing circuitry 901 of the apparatus 900 to perform the method described herein in relation to the apparatus 900. Alternatively, or in addition, the memory 903 of the apparatus 900, can be configured to store any requests, resources, information, data, signals, or similar that are described herein. The processing circuitry 901 of the apparatus 900 may be configured to control the memory 903 of the apparatus 900 to store any requests, resources, information, data, signals, or similar that are described herein. The apparatus 900 may be configured operate in the manner described herein in respect of an apparatus.

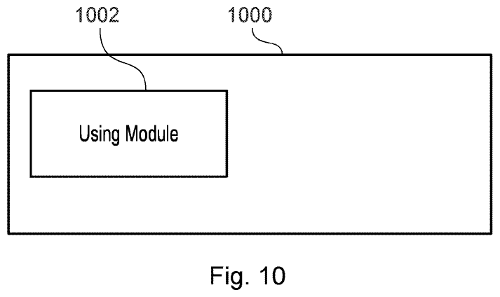

FIG. 10 is a block diagram illustrating an apparatus 1000 according to some embodiments. The apparatus 1000 comprises a using module 1002 configured to use a GNN model, wherein the GNN model is trained as described with reference to any of the embodiments herein.

The apparatus 1000 may operate in the manner described herein in respect of an apparatus.

There is also provided a computer program comprising instructions which, when executed by processing circuitry (such as the processing circuitry 701 of the apparatus 700 described earlier), cause the processing circuitry to perform at least part of the method described herein. There is provided a computer program product, embodied on a non-transitory machine-readable medium, comprising instructions which are executable by processing circuitry to cause the processing circuitry to perform at least part of the method described herein. There is provided a computer program product comprising a carrier containing instructions for causing processing circuitry to perform at least part of the method described herein. In some embodiments, the carrier can be any one of an electronic signal, an optical signal, an electromagnetic signal, an electrical signal, a radio signal, a microwave signal, or a computer-readable storage medium.

Embodiments described herein enable a parameter search algorithm to estimate the QoS KPI of a combination of parameters of one/many cells within a second. This enables an NDO to explore a large design space of the CM configuration parameters within short period of time (e.g. seconds or milliseconds).

Embodiments described herein are migratable to edge (e.g. the inference stages) as the GNN model may only require information from certain hops of topological neighbouring cells.

Instead of the centric design of NDO as now, one can offload this configuration task to the edge/gNB and pave the way towards a self-optimized Radio Access Network (RAN). In some embodiments, hops may be instead referred to as an order, or degrees, of separation between topological neighbouring cells.

Embodiments described herein only require a small amount of ground truth data. Through the proposed training method, for example only 2.5% of ground truth data is required. This reduces the need to perform road tests and/or UE measurement reports, which reduces the operational cost of NDO.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A method for training a graph neural network, GNN, model the method comprising:
obtaining a graph representation of a network, wherein the graph representation comprises:
a set of nodes, V, wherein each node represents a radio coverage area; and
a set of edges, E, wherein each edge connects two nodes in the set of nodes and represents a relationship between the two nodes;
obtaining sets of geometric features, G, associated with overlaps between respective radio coverage areas associated with at least some edges in the set of edges;
conducting a first phase of training using one or more first output layers for the GNN model, wherein the first phase of training comprises training the GNN model to predict the sets of geometric features;
after the first phase of training, selecting at least one first parameter of the GNN model to fix; and
conducting a second phase of training using one or more second output layers in the GNN model to predict performance metrics associated with the set of nodes, wherein the second phase of training comprises training the GNN model with the at least one first parameter fixed.

2. (canceled)

3. The method as claimed in claim 1, wherein each of the spatial configurations comprise one or more of:
an interference area of the respective radio coverage area that interferes with one or more other radio coverage areas;
a distance from the node to a centre of the interference area; and
a location of the centre of the interference area.

4. The method of claim 1, wherein the first phase of training further comprises:
adjusting one or more second parameters associated with one or more first input layers of the GNN model.

5-6. (canceled)

7. The method of claim 1, wherein the second phase of training further comprises:
adjusting one or more third parameters of the GNN model comprising one or more of:
a parameters associated with one or more second output layers; and
a parameters associated with one or more second input layers.

8-9. (canceled)

10. The method of claim 1, further comprising obtaining first training configuration management, CM, parameters from the set of nodes.

11. The method as claimed in claim 10 further comprising:
determining the one or more sets of geometric features from the first training CM parameters.

12. The method of claim 11, wherein the CM parameters comprise one or more of:
a beamwidth of a radio coverage area provided by a node; a maximum transmission Power, a multiple-input and multiple-output (MIMO) scheme, an antenna height, an antenna orientation, an antenna electrical tilt, an antenna mechanical tilt, a sector identification, a carrier frequency, Downlink/Uplink E-UTRA Absolute Radio Frequency Channel Number.

13. (canceled)

14. The method as claimed in claim 1, wherein conducting the second phase of training comprises:
obtaining second training configuration management, CM, parameters from the set of nodes; and
inputting the second training configuration management parameters into the GNN model.

15. The method of claim 1, wherein each edge in E has a direction.

16. The method of claim 1, wherein the graph representation further comprises a set of node attributes, X, wherein each node attribute represents configuration parameters of a radio coverage area.

17. The method of claim 1, wherein the graph representation further comprises a set of edge attributes, Y, wherein each edge attribute represents an inter-radio coverage area property between a source node and a destination node.

18. The method of claim 17, wherein each edge attribute comprises one of:
a representation of a geographical distance between the source node and the destination node;
an indication of an inter-radio coverage area relation type being one or more of:
interfering and complementing; and
a representation of a strength of the inter-radio coverage area relation.

19. The method of claim 1, wherein the graph representation further comprises sets of measurement features, M.

20. The method as claimed in claim 19, wherein the sets of measurement features comprise representations of measured Received Signal Strength Indicators, RSSI.

21-24. (canceled)

25. An apparatus for training a graph neural network, GNN, model the apparatus comprising processing circuitry configured to cause the apparatus to:
obtain a graph representation of a network, wherein the graph representation comprises:
a set of nodes, V, wherein each node represents a radio coverage area; and
a set of edges, E, wherein each edge connects two nodes in the set of nodes and represents a relationship between the two nodes;
obtain sets of geometric features, G, associated with overlaps between respective radio coverage areas associated with at least some edges in the set of edges;
conduct a first phase of training using one or more first output layers for the GNN model, wherein the first phase of training comprises training the GNN model to predict the sets of geometric features;
after the first phase of training, select at least one first parameter of the GNN model to fix; and
conduct a second phase of training using one or more second output layers in the GNN model to predict performance metrics associated with the set of nodes, wherein the second phase of training comprises training the GNN model with the at least one first parameter fixed.

26-29. (canceled)

30. A computer program product comprising non transitory computer readable media having stored thereon a computer program comprising instructions which, when executed on at least one processor, cause the at least one processor to carry out a method according to claim 1.
